(19) United States
(12) Patent Application Publication
(10) Pub. No.: US 2004/0153341 A1
(43) Pub. Date: Aug. 5, 2004

(54) System for analyzing and processing orders related to healthcare treatment or services

(76) Inventors: Samuel I. Brandt, Malvern, PA (US); Harm J. Scherpbier, Fort Washington, PA (US); Robert P. Spena, Downingtown, PA (US)

Correspondence Address: Alexander J. Burke, Intellectual Property Department, 5th Floor, 170 Wood Avenue South, Iselin, NJ, 08830, US

(21) Appl. No.: 10/730,593

(22) Filed: Dec. 8, 2003

Related U.S. Application Data
(60) Provisional application No. 60/431,900, filed on Dec. 9, 2002.

(51) Int. Cl. G06F 17/60

(52) U.S. Cl. 705/2

(57) ABSTRACT

A system analyzes data including healthcare orders initiating treatment or services used in patient healthcare. The system includes a data processor and a message processor. The data processor identifies a potential change in use of a particular treatment by examining data, representing multiple orders generated over a particular time period, used in treating multiple patients to identify a number of orders initiating application of a particular treatment to individual patients of the multiple patients to address a particular medical condition. The data processor also determines whether the number of orders exceeds a predetermined threshold and/or whether a rate of change in the number of orders relative to a previously determined number of orders is significant. The message processor initiates generation of a message to alert a message recipient of an identified potential change in use of the particular treatment.

### CROSS-REFERENCE TO RELATED APPLICATIONS

The present application is a non-provisional application of provisional application having serial No. 60/431,900 filed by Samuel I. Brandt, et al. on Dec. 9, 2002.

### FIELD OF THE INVENTION

The present invention generally relates to information systems. More particularly, the present invention relates to a healthcare information system involving analyzing orders for healthcare treatment or services.

### BACKGROUND OF THE INVENTION

In a healthcare enterprise, such as a hospital, order sets and documentation templates each facilitate consistency in patient therapy. Traditionally, an order set or a documentation template is associated with a single clinical factor such as “pneumonia” or “cardiac catheterization preoperative orders.” Prospective consideration of the clinical factor determines the order set or the documentation template and the identification of orders or documentation elements, respectively, that is appropriate for the care of patients having the clinical factor.

Unfortunately, growth of the quantity of each of the order sets and the documentation templates create a burden on personnel and/or systems to maintain (i.e., review and update) the order sets and the documentation templates. Further, it is difficult to provide consistency for individual elements, which appear in multiple order sets and multiple documentation templates, because each order set or document template is developed and maintained individually.

Various approaches to maintaining order sets and the documentation templates are inadequate. Common approaches include the systematic review of medical literature, identification of important changes in practice, review by expert committees, and when deemed appropriate, the inclusion of any changes in the appropriate members of each of the order sets and documentation templates. Alternately, the contents of the order sets and the documentation templates are systematically reviewed in a rolling fashion, providing for a periodic refresh of each template. Both approaches require a very high effort to value ratio, either reviewing an enormous amount of literature in order to identify a relatively small number of required changes, or reviewing an enormous number of order sets and documentation templates on a periodic basis to identify a relatively small number of needed changes.

In view of the foregoing, it would be desirable to provide a system that would lessen the burden of maintaining the order sets and the documentation templates. Accordingly, there is a need for a healthcare information system involving analyzing orders for healthcare treatment or services that overcomes these and other disadvantages of the prior systems.

### SUMMARY OF THE INVENTION

According to one aspect of the present invention, a system analyzes data including healthcare orders initiating treatment or services used in patient healthcare. The system includes a data processor and a message processor. The data processor identifies a potential change in use of a particular treatment by examining data, representing multiple orders generated over a particular time period, used in treating multiple patients to identify a number of orders initiating application of a particular treatment to individual patients of the multiple patients to address a particular medical condition. The data processor also determines whether the number of orders exceeds a predetermined threshold and/or whether a rate of change in the number of orders relative to a previously determined number of orders is significant. The message processor initiates generation of a message to alert a message recipient of an identified potential change in use of the particular treatment.

This aspect and other aspects of the present invention are further described with reference to the following detailed description and the accompanying figures, wherein the same reference numbers are assigned to the same features or elements illustrated in different figures.

### BRIEF DESCRIPTION OF THE DRAWINGS

FIG. 1 illustrates a block diagram of a healthcare information system, in accordance with a preferred embodiment of the present invention.

FIG. 2 illustrates a method for analyzing orders for healthcare treatment or services in a healthcare information system, as shown in FIG. 1, in accordance with a preferred embodiment of the present invention.

FIG. 3 illustrates a graph showing a frequency distribution of orders placed for any single clinical problem, in accordance with a preferred embodiment of the present invention.

FIG. 4 illustrates a graph showing a diagram showing a cluster of multiple clinical problems for a patient, in accordance with a preferred embodiment of the present invention.

FIG. 5 illustrates a graph showing a diagram showing a patient's needs, represented as a constellation of patient attributes (i.e., patient problems), corresponding to a cluster of order sets addressing the patient attributes, in accordance with a preferred embodiment of the present invention.

FIG. 6 illustrates a graph showing a frequency distribution of unique combinations of specific individual orders (i.e., a member set), in accordance with a preferred embodiment of the present invention.

FIG. 7 illustrates a graph showing a frequency distribution of a first particular order in a first particular member set, in accordance with a preferred embodiment of the present invention.

FIG. 8 illustrates a graph showing a frequency distribution of a second particular order in a second particular member set, in accordance with a preferred embodiment of the present invention.

FIG. 9 illustrates a graph showing a three dimensional plot of the membership of each order clustered with a member set of optimal size for reuse, in accordance with a preferred embodiment of the present invention.

Table 1 illustrates a list of attributes associated with a patient's clinical problem, in accordance with a preferred embodiment of the present invention.

Table 2 illustrates a list of orders associated with a patient's clinical problem, in accordance with a preferred embodiment of the present invention.

Table 3 illustrates a list of patient attributes (i.e., patient problems), as shown in Table 1, correlated with a list of orders, as shown in Table 2, in accordance with a preferred embodiment of the present invention.

Table 4 illustrates the orders, as shown in Table 3, grouped under corresponding attributes, as shown in Table 3, in accordance with a preferred embodiment of the present invention.

Table 5 illustrates a one particular order set from the patient's problem, as shown in Table 4, that is combined with other order sets from other patient's problems, in accordance with a preferred embodiment of the present invention.

Table 6 illustrates a number of possible combinations of the orders, as shown in Table 2, in accordance with a preferred embodiment of the present invention.

### DETAILED DESCRIPTION OF THE PREFERRED EMBODIMENTS

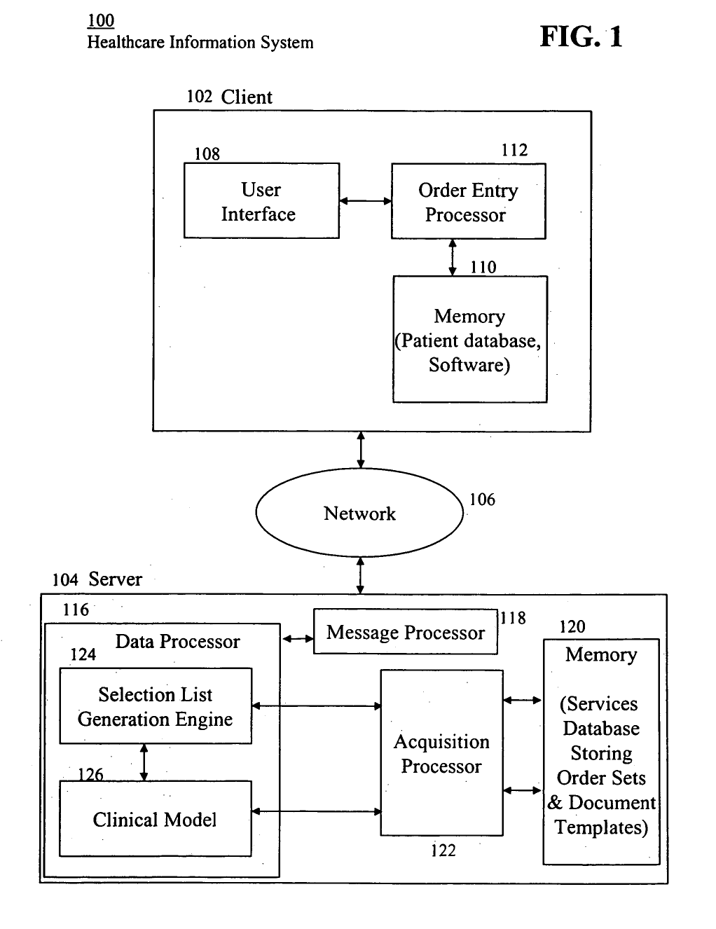

FIG. 1 illustrates a block diagram of a healthcare information system 100, in accordance with a preferred embodiment of the present invention. The system 100 is intended for use by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a skilled nursing facility, a physical therapy clinic, a chiropractic clinic, and a dental office. In the preferred embodiment of the present invention, the healthcare provider is a hospital. Examples of the people being serviced by the healthcare provider include, without limitation, a patient, a resident, and a client.

The system 100 generally includes a client 102, a server 104, and a network 106. Together, the client 102 and the server 104 preferably form a client-server computer architecture advantageously permitting the client 102 to be located remotely from the server 104, as is well known in the art. Alternatively, the client 102 and the server 104 may form an integral computer architecture requiring the client 102 and the server 104 to be located near one another, as is well known in the art.

The client 102 communicates with the server 104 over the network 106 via one or more communication paths or links. Each of the client 102 and the server 104 includes communication interfaces for transmitting and/or receiving information over the network 106. The communication paths may be unidirectional or preferably bi-directional, as required or desired. The network 106 may be implemented as a local area network (LAN), such as an intranet, or a wide area network (WAN), such as an Internet, or a combination thereof. Preferably, the network 106 is a combination of a LAN, formed by an Intranet, and a WAN, formed by an Internet.

The client 102 and the server 104 are adapted to communicate over the network 106 using one or more data formats, otherwise called protocols, depending on the type and/or configuration of the various elements in the system 100. Examples of the information system data formats include, without limitation, an RS232 protocol, an Ethernet protocol, a Medical Interface Bus (MIB) compatible protocol, an Internet Protocol (IP) data format, a local area network (LAN) protocol, a wide area network (WAN) protocol, an IEEE bus compatible protocol, and a Health Level Seven (HL⁷) protocol.

The client 102 and the server 104 are adapted to communicate over the network 106 using a wired or wireless (W/WL) connection. Preferably, the communication paths are formed as a wired connection. In the case of a wired connection, the IP address is preferably assigned to a physical location of the termination point of the wire, otherwise called a jack. The jack is mounted in a fixed location near the location of the various elements of the system 100. In the case of a wireless connection, IP addresses are preferably assigned to the client 102 and/or the server 104, since one or both would be mobile. The wireless connection permits a person using the system 100 to be mobile beyond the distance permitted with the wired connection.

The client 102 further includes a user interface 108, a memory device 110, and an order entry processor 112, and generally are connected to each other, as shown in FIG. 1, to operate in a manner well known to those skilled in the art of client devices. The order entry processor 112 communicates with the user interface 108, the memory 110, and the network 106, in a manner well known to those skilled in the art of client devices. The order entry processor 112 may be implemented in software and/or hardware and operates responsive to a software program stored in the memory 110.

The client 102 is preferably implemented as a personal computer. The personal computer may be fixed or mobile and may be implemented in a variety of forms including, without limitation, a desktop, a laptop, a personal digital assistant (PDA), and a cellular telephone.

The client 102 generally represents healthcare sources, otherwise known as individual systems themselves, which need access to patient information, such as clinical information, order sets, and document templates. Examples of the healthcare sources include, without limitation, a hospital system, a medical system, and a physician system, a records system, a radiology system, an accounting system, a billing system, and any other system required or desired in a healthcare information system. The hospital system further may include, without limitation, a lab system, a pharmacy system, a financial system, and a nursing system. The medical system represents a healthcare clinic or another hospital system. The physician system represents a physician's office. Typically, the systems in the hospital system are physically located within the same facility or on the same geographic campus. However, the medical system and the physician system are each typically located in a different facility at a different geographic location. Hence, the healthcare sources represent multiple, different healthcare sources that need access to patient information order sets, and document templates, and that may have various physical and geographic locations.

The user interface 108 generally includes an input device and an output device (each not shown). The input device permits a user to input information into the client 102 and the output device permits a user to receive information from the client 102. Preferably, the input device is a keyboard, but also may be a touch screen, a microphone with a voice recognition program, for example. Preferably, the output device is a display, but also may be a speaker, for example. The output device provides information to the user responsive to the input device receiving information from the user or responsive to other activity by the client 102. For example, the display presents information to the user, responsive to the user entering information in the client 102 via the keypad, as shown in some of the figures herein.

Preferably, the user interface 108 is a graphical user interface (GUI), wherein at least portions of the input device and at least portions of the output device are integrated together to provide a user-friendly device. For example, a web browser forms a part of each of the input device and the output device by permitting information to be entered into the web browser and by permitting information to be displayed by the web browser. Many different GUI techniques for inputting data and outputting data, preferably using a browser interface, may be implemented for efficiency and ease of use including, without limitation, selection lists, selection icons, selection indicators, drop down menus, entry boxes, slide bars, search queries, hypertext links, Boolean logic, template fields, natural language, stored predetermined queries, system feedback, and system prompts. The server 104 may also have a user interface (not shown), having an input device and an output device, which operates in the same or different way than the user interface 108 of the client 102.

The memory device 110 stores patient records in the form of a patient database, and stores software appropriate for the client 102. The patient records, otherwise called patient data files or patient medical record repository, stored in the memory 110 generally include any information related to a patient's health and welfare, and preferably include any information related to a patient's health problems recorded on the order sets and/or documentation templates. Examples of patient records related to a patient's health and welfare generally include, without limitation, biographical, financial, clinical, workflow, patient vital signs, and care plan information. Examples of patient records related to a patient's vital signs include, without limitation, a patient's heart rate, respiratory rate, blood oxygen saturation indicator, ventilation related data indicator, and an anatomical electrical activity indicator. Examples of patient records related to a patient's health problems recorded on the order sets and/or documentation templates include, without limitation, those listed in Table 1 herein below.

The patient data files stored in the memory 110 may be represented in a variety of file formats including, without limitation and in any combination, numeric files, text files, graphic files, video files, audio files, and visual files. The graphic files include a graphical trace including, for example, an electrocardiogram (EKG) trace, an electrocardiogram (ECG) trace, and an electroencephalogram (EEG) trace. The video files include a still video image or a video image sequence. The audio files include an audio sound or an audio segment. The visual files include a diagnostic image including, for example, a magnetic resonance image (MRI), an X-ray, a positive emission tomography (PET) scan, or a sonogram.

The patient data files stored in the memory 110 are an organized collection of clinical information concerning one patient's relationship to healthcare provided by a healthcare enterprise (e.g. region, hospital, clinic, or department). Preferably, the healthcare is documented using order sets and document templates. Hence, the history of the patient's care by the healthcare providers in the healthcare enterprise is represented in the patient data files.

The server 104 further includes a data processor 116, a message processor 118, a memory 120, and an acquisition processor 122, wherein the elements of the server 104 are connected to each other, as shown in FIG. 1. The server 104 is preferably implemented as a personal computer or a workstation.

The data processor 116 further includes a selection-list generation engine 124 and a clinical model 126. The processor 116 manages the functions of the server 104. The data processor 116 further manages the communications between the server 104 and the client 102, via the message processor 118 (otherwise called a communication interface). The acquisition processor 122 manages the communications between the data processor 116 and the memory 120. Each of the data processor 116, the message processor 118, and the acquisition processor 122 may be implemented in software and/or hardware and operates responsive to a software program stored in the memory 120. Further, the data processor 116, the message processor 118, and the acquisition processor 122 may be formed as separate processors or a single processor.

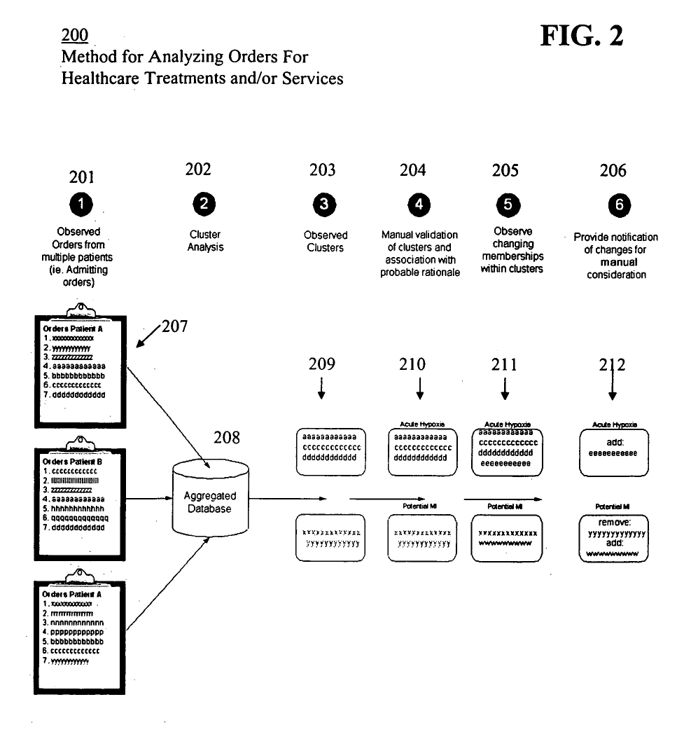

The memory 120 stores software to implement a method 200 for analyzing orders for healthcare treatments and/or services described herein, as described in FIG. 2 and supported by the remaining figures and the tables. The memory 120 also stores services in the form of a database, including without limitation, order sets and document templates, as described herein. Preferably, the memory 120 that holds software to implement a method for analyzing orders is implemented in read only memory (ROM), or other suitable memory unit that runs a predetermined software program while the server 104 is in use. Preferably, the memory 120 that stores the order sets and document templates is implemented in random access memory (RAM), or other suitable memory unit that can be refreshed, cached, or updated while the server 104 is in use.

In the preferred embodiment of the present invention, the system 100 and the method 200 provide an aggregate analysis of orders and documentation generated by healthcare clinicians, such as physicians. Using correlation techniques, such as clustering, sets of frequently associated orders and documentation elements are identified. Through analysis of the correlation contents, and associated patient information, the rationale for each correlation is identified. Ongoing surveillance permits the observation of changes to correlation contents, such as the appearance of new diagnostic/therapeutic measures for a given condition. This is used in concert with an alerting mechanism to inform an editorial board of the changes in observed clinical practice, providing an explicit mechanism for identifying order sets and/or documentation templates that require modification.

The system 100 and the method 200 provide a much lower effort to value ratio, by observing changes in medical practice which have been adopted by healthcare clinicians, and using these changes to alert an editorial board of the need for review. The system 100 and the method 200 assume that the healthcare clinicians in practice are monitoring the literature in their field and the evolving knowledge within their specialties, and are making appropriate decisions regarding when to incorporate new behaviors into their practice. Thus, the system 100 and the method 200 avoids the deficiencies of a centralized approach, wherein the editorial board that makes decisions about new clinical information is isolated from issues, such as cost, reimbursement, patient acceptance, and patient impact, regarding the adoption of the new information. By the system 100 and the method 200 reviewing (i.e., conducting surveillance) a large sample of clinical practice information, the emergence of new items associated with previously identified clusters, and the rate of change of their adoption, appropriate targets for inspection may be identified.

FIG. 2 illustrates a method 200 for analyzing orders for healthcare treatment or services in a healthcare information system 100, as shown in FIG. 1, in accordance with a preferred embodiment of the present invention. The method generally includes six steps 201-206.

At step 201, the method 200 acquires data representing the multiple orders 207 used in treating multiple patients and for associating an individual order with the particular medical condition and/or a set of medical conditions including the particular medical condition. Preferably, the acquisition processor 112 (FIG. 1) performs step 201 (FIG. 2) of the method 200.

Alternatively or in combination, at step 201, the method 200 also acquires data identifying multiple medical conditions exhibited by an individual patient and applies the data identifying the multiple medical conditions, exhibited by the individual patient, in associating the individual order with the the particular medical condition and/or a set of medical conditions including the particular medical condition.

Preferably, at step 201, the method 200 derives data identifying the multiple medical conditions and potentially associated sub-conditions. A potentially associated sub-condition of a medical condition is identified using a clinical knowledge model 126 that associates medical conditions based upon one or more of the following: potential etiology, potential complication, clinical associations, and a combination thereof. Preferably, the data identifying the multiple medical conditions exhibited by the individual patient is acquired from a stored patient record, such as in the memory 110.

Further, alternatively or in combination, at step 201, the method 200 acquires data identifying multiple medical conditions exhibited by an individual patient, and applies the data identifying the multiple medical conditions exhibited by the individual patient in associating the individual order with the particular medical condition, and/or a set of medical conditions including the particular medical condition.

At step 202, the method 200 identifies a potential change in the use of a particular treatment by examining data, representing multiple orders generated over a particular time period to treat multiple patients, to identify a number of orders that initiate application of a particular treatment to individual patients of the multiple patients to address a particular medical condition. Preferably, the data processor 116 performs step 202 of the method 200.

Preferably, the data processor 116 correlates data representing a particular order of the multiple orders with one or more of the following: the particular medical condition, another order of the multiple orders, and a documentation template used for initiating an order. Preferably, the data processor 116 performs the correlation using one or more of the following: cluster analysis, best-fit analysis, and a statistical correlation technique. Preferably, the correlated data are collected (i.e., aggregated) and stored in a database 208, which may be the same as the memory 120, as shown in FIG. 1.

Preferably, at step 202, the method 200 reviews data representing orders to identify the data representing the multiple orders for examination based on one or more elements. The elements include a predetermined particular order item in an order set, a predetermined particular order documentation template, a source of a predetermined particular order, and a predetermined particular medical condition likely to be associated with an order. Hence, at step 202, the method determines clinically significant patient information that is used to identify cluster rationale.

Preferably, cluster analysis techniques, such as fuzzy cluster analysis, provide a mechanism for analyzing large volumes of data, and identifying subsets of individual elements that are associated frequently within the data. For example, when analyzing a large volume of hospital orders placed within the first 24 hours admission, for a large number of patients, by a large number of physicians, there are patterns that can be predictably identified. For example, almost all patients would have an order for an intravenous fluid. However, patients with large infusion volumes would often be associated with conditions that relate to low blood pressure such as blood loss and dehydration. Some of these patients would also have orders for blood products, for clotting factors, and for tests that monitor for blood loss. Others would have associated orders relating to hydration status such as electrolytes, urine output, and urine osmolality. Within the data, any single order or documentation element may be associated with any single other order or document element, respectively, with high frequency. A cluster of three particular orders will be associated with each other with a lower frequency. As the number of orders within a cluster is increased, the frequency of association decreases. Hence, cluster analysis techniques, such as fuzzy cluster analysis, provide for the identification of cluster sets, and cluster sizes that provide a mathematical best fit. The system 100 and the method 200 preferably use this technique to identify associated elements within the data.

At step 203, the method 200 identifies (i.e., observes or analyzes) a potential change in the use of a particular treatment by determining whether the number of orders or documentation elements 209 (i.e., clusters) exceeds a predetermined threshold, and/or whether a rate of change in the number of orders 209 relative to a previously determined number of orders is significant (i.e., those that appear to be frequently associated). Hence, at step 203, the method 200 permits viewing of cluster membership. Preferably, the data processor 116 performs step 203 of the method 200.

At step 204, the method 200 permits one or more persons manually review and validate the correlated (e.g., clustered) data 210 and association with the probable rationale. This manual validation process advantageously ensures that the correlated data that the data processor 116 automatically observes and presents are consistent with human logic and professional common sense.

After elements of the clinical orders or other clinical documentation are associated with each other, such as by clustering, clinically knowledgeable individuals review the elements within the order set and decide whether all of the members should be mapped together to a single rationale. For example, patients undergoing coronary artery bypass surgery typically lose a significant volume of blood. Therefore, these patients frequently receive blood products, and have orders associated with blood loss as stated above. Gunshot victims also frequently lose large amounts of blood and require blood replacement. The cluster analysis may well identify patients who are both undergoing coronary artery bypass surgery and receiving blood replacement. Clinically knowledgeable review of the elements of the order set could reveal that some of the orders are best assigned to the coronary artery bypass procedure, and others to hemorrhagic anemia. This could allow the members of the hemorrhagic anemia cluster to be consistent for both gunshot victims and coronary artery bypass recipients. Thus, the clinical model 126 is refined based on knowledgeable review of cluster elements.

At step 205, the method 200 observes changing memberships 211 within the correlated data 210 (i.e., clusters). After cluster membership is refined by knowledgeable review, the correlated data is reprocessed through multiple iterations, permitting the identification of associations between clusters. For example, after hemorrhagic anemia membership is defined, a large number of procedures and conditions that result in hemorrhagic anemia could be identified through order clusters associated with each of the procedures and conditions.

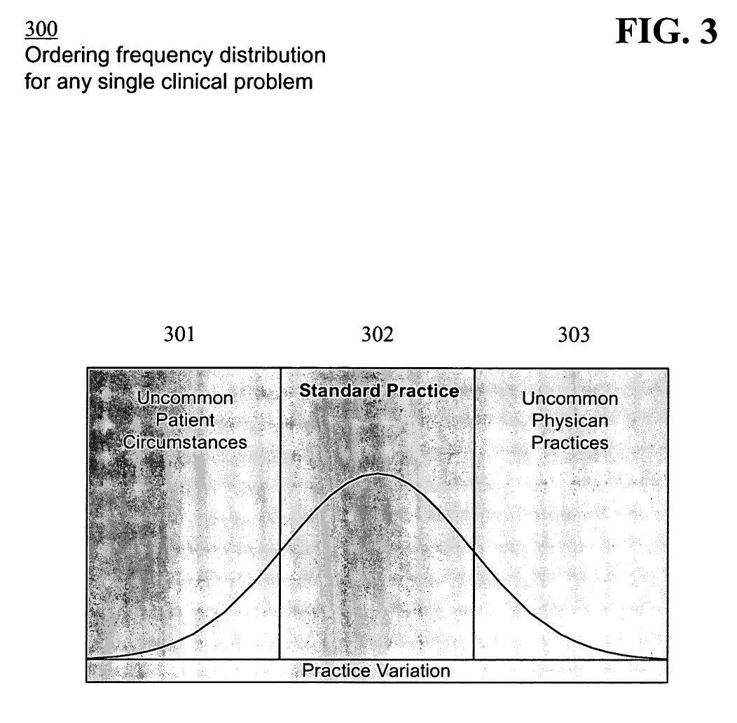

After the system 100 and the method 200 create a clinical model 126 of order set rationale and membership (and documentation element rationale and membership), the system 100 and method 200 monitor changes in the membership of individual clusters. For example, Troponins (further explained with FIG. 3) could be observed to be associated with a myocardial infarction evaluation cluster with increasing frequency. The system 100 and method 200 uses predetermined threshold levels of association to trigger notification to a review process, and also acceleration of the rate of adoption, to permit minimally used order/documentation element to be brought to the attention of reviewers because it's rate of adoption was rapidly accelerating. In a like manner, cluster members whose frequency of association is declining can be brought to the attention of reviewers based on a predetermined threshold level use and/or a rate of change of use.

At step 206, the method 200 initiates generation of a message 212 to alert a message recipient (e.g., a user of the client 102) of an identified potential change in use of the particular treatment. Preferably, the potential change in use of the particular treatment includes, without limitation, a change in frequency of use of the particular treatment by physicians to treat the particular medical condition and/or a change in type of medical condition treated with the particular treatment. Preferably, at step 206, the method 200 initiates generation of a message prompting a user with a suggestion of an additional order item to be added to an existing order set documentation template, and/or a deletion of an order item from an existing order set documentation template. Hence, at step 206, the method 200 provides a notification mechanism for newly identified correlated data (i.e., clusters), and of emerging changes of cluster membership, through the functionality of a selection list provided by the selection-list generation engine 124 (FIG. 1). Preferably, the message processor 118 performs step 206 of the method 200.

Preferably, at step 206, the method 200 receives a reply message (otherwise called a second message) in response to generating the message. Preferably, a user generates the reply message responsive to reviewing the correlated data at step 204. The reply message initiates an addition of an order item to an existing order set documentation template, and/or a deletion of an order item from an existing order set documentation template.

Hence, the method 200 provides a clinical order and/or documentation maintenance process in a healthcare information system 100 to create and maintain order sets and/or documentation elements, respectively. Clinical orders and clinical documentation represent the services and/or treatments provided to patients by healthcare providers. Thus, the method correlates data between the kinds of orders and/or documentation written and the recorded elements of the order and/or documentation, and the patient's clinical status.

FIG. 3 illustrates a graph 300 showing a frequency distribution of orders placed for any single clinical problem, in accordance with a preferred embodiment of the present invention. The system 100 and the method 200 advantageously create order sets that fit physician practices by deriving them from observed practice. For any given clinical condition, the orders placed by physicians typically fall upon a statistical bell curve, as shown in FIG. 3. Competent physicians typically deliver a standard of healthcare that is employed in common practice 302, which is represented in the graph 300 by orders falling within +/−1 standard deviation. Orders that fall outside of this range do so either because the patients being treated have other problems/circumstances/conditions 301 that are not represented by the stated clinical problem (and should therefore be placed into some other order set), or because the physician is practicing outside of common practice 303 (either innovatively or inappropriately). In either case, capturing the most common orders 302 and excluding the least common 301 and 303, provides the most stable implementation of the present invention.

Typically, a physician writes between 35 and 50 orders when admitting a patient to the hospital. Because these orders are intended for a specific patient, they represent the intersection of the physician's medical knowledge and the patient's needs. The orders themselves represent a collection of order clusters, each directed at one or more specific patient problems.

For example, a physician writes multiple orders for a patient admitted with chest pain. Some orders are directed towards assessing whether the patient has had a myocardial infarction. Some orders are directed towards excluding other causes of chest pain such as a pulmonary embolism or aortic dissection. Some orders are directed towards providing access for advanced cardiac life-support should the patient have a cardiac arrest. Some orders are directed towards providing oxygenation. Further, some orders are directed towards increasing coronary perfusion.

Therefore looking over admission orders from multiple patients, one could expect to see clusters of orders targeted towards oxygenation, or assessment of a myocardial infarction. As this new knowledge is integrated within clinical practice, one could expect to see these clusters evolve. For example, until recently myocardial infarctions were typically ruled out with electrocardiograms and CPK MB sub-fractions. Recently, two new tests, Troponin I and Troponin T were introduced. These are more sensitive and more specific, as well as being more predictive of outcome. By observing large numbers of admission orders, one could expect to see clusters including CPK and EKGs, with initially low incidences of Troponins, which overtime would gradually increase in frequency as Troponin gained market penetration.

Without the use of an active problem list, one could observe this cluster, but not necessarily be able to associate to it the medical condition that it addresses. However, physicians could be readily able to examine the cluster contents and infer the most likely intention.

Further, one might observe formerly coherent clusters that begin to subdivide. For example, screening of women for breast cancer was typically conducted for women over 50 years of age. New information provided by genomics can subdivide women based on anomalities, such as gene anomalies and their associated cancer risk. Therefore, one could expect to see new patterns emerging, subdividing women without the anomalies, and women with the anomalies.

In the preferred embodiment, an order set and documentation template is a self-learning system 100 and method 200, which observes orders and documentation elements related to specific clinical indications, and aggregates their frequencies and configurations, so that these can be rolled into new and updated order sets. The advantages of the system 100 and the method 200 include, without limitation, the following:

1. They provide a mechanism for developing and maintaining order sets that remain current with real clinical practice 2. They avoid the implementation hurdles associated with transferring standards between institutions.

3. They provide for automated generation of order sets for every new specialty and procedure.

4. They improve implementation order sets, by filling in missing items, and by filling in missing order sets.

5 They reward physicians for bothering to include new orders by incorporating their changes into evolving order sets.

The order set self learning function, and the order set dynamic change capability with its associated clinical conceptual model 126, are complementary. This is because dynamic order sets reflect real-world clinical practice. For example, two physicians may treat two patients with pneumonia differently. However, the first patient may be a frail, elderly patient who is immune compromised while the second may be a young a healthy patient. The physicians' choice of antibiotics, oxygen, and monitoring will differ between the two patients. However, if the first patient's order set incorporated subsets to include “immune compromised pneumonia,” and “frail elderly” conditions, then we would find that there is a high degree of consistency in the practice of pneumonia for patients with those conditions. Fortunately, the present approach allows us to start with a more simplistic order set model 126, by aggregating all of the orders for pneumonia patients, and including only those in the order set that fall within the desired frequency cutoffs. If a large number of patients are immune compromised, then the orders associated with these patients are included in the model 126. If a large number of patients are not immune compromised, then they will fall outside of the model 126.

The system 100 and the method 200 capture orders being placed for patients, and relate them to both the indications associated with order sets that the physician used, as well as with the patient's problems. A patient may have multiple problems, some stated, and some unstated. Therefore, individual orders need to be captured along with collective data describing all of the patients' known problems and selected order set indications. The items are examined to determine whether they already fall within existing order sets, in which case, they can be assumed to add to the frequency distribution of those order sets. If not, then a knowledgeable physician would review the new order, and manually assign it. Preferably, this is done on collective (i.e., aggregated) basis, so that only orders that exceed a predetermined frequency of use are brought to the attention of a physician for mapping. The method 200 is advantageously more efficient than the prior process of surveying medical literature and manually incorporating new practices within order sets. In the preferred embodiment, the order sets are changed in response to the observed changes in physician ordering practices.

For example, consider the use of insulin Lispro, for treatment of diabetic ketoacidosis. Lispro is a relatively new human insulin analog that has the advantage of a shorter onset of action, and a shorter duration of action. Lispro is currently not approved for use in insulin drips, however it has been studied in this capacity, and in many institutions has replaced the use of regular insulin for insulin drips. Consider that an order set exists for the indication “ketoacidosis.” The order set includes an insulin regular admixture order. However, with increasing frequency, physicians do not select this order, but instead navigate through the order search tool, select Lispro, specify the admixture, and add it to the patient's orders. By capturing this order, and its association with “ketoacidosis,” the system 100 and method 200 detect a pattern of the use of this medication for that indication. Therefore, once the usage volume of Lispro exceeds a predefined threshold, Lispro is included within the ketoacidosis order set (as an unselected order that the physician may explicitly choose). Further, as the use of regular insulin for drips declines, the system 100 and method 200 observe this decline, and once regular insulin falls below a prdetermined threshold, regular insulin is removed from the ketoacidosis order set.

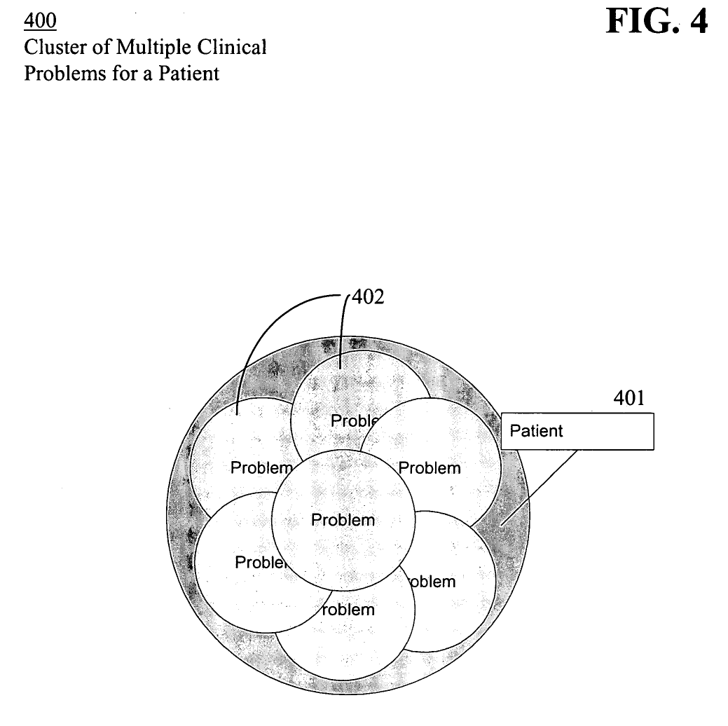

FIG. 4 illustrates a diagram 400 showing a cluster of multiple clinical problems 402 for a patient 401, in accordance with a preferred embodiment of the present invention. Preferably, the client 102 displays the diagram 400 using the user interface 108, such as on a display. Patients with clinical disease typically have numerous coexisting health problems. Further, each of these problems is associated with potential causes and potential complications. Healthcare clinical orders and/or other clinical documentation) represent these problems. FIG. 4 is further explained in consideration with the following four tables, Tables 1-4.

Table 1 illustrates a list of attributes associated with a patient's clinical problem, in accordance with a preferred embodiment of the present invention. A patient can be categorized with a list of attributes, which described the rationale for the orders and documentation elements selected for the patient. Table 1 describes the following attributes associated with a patient's problem.

TABLE 1

Chest pain
Type II diabetic, suboptimal control
Hypertensive
Mild congestive heart failure, stable
Known coronary vascular disease
Diabetic nephropathy
Peripheral neuropathy
Rule out myocardial infarction
Rule out pneumonia
Rule out pulmonary embolism
Risk for tissue hypoxia
Risk for arrhythmia
Admission to telemetry unit

Table 2 illustrates a list of orders associated with a patient's clinical problem, in accordance with a preferred embodiment of the present invention. Orders written for this patient and the documentation elements selected for this patient reflect the patient's clinical problem. Table 2 represents a typical admission order collection for the patient's clinical problems.

```
TABLE 2
  1. Admit to telemetry
  2. Diagnosis: chest pain
  3. Vital signs q one hour
  4. Strict intake and output
  5. Bed rest with bedside commode
  6. IV: D5 1/2 normal saline with 20 milliequivalents kcl/liter via large
    bore catheter at KVO
  7. Pulse oximetry continuous monitoring
  8. ABG stat
  9. 02, two liters per nasal cannula
10. Nitroglycerin drip, titrate per protocol
11. EKG q 12 hours times three
12. CPK MB stat and q 8 hours times two
13. Troponin I stat, now and at 12 hours
14. D-dimer stat
15. Portable chest x-ray stat
16. Aspirin 325 mg q.d.
17. Lasix 20 mg PO q.d.
18. Glucometer reading prior to each meal and at bedtime
19. Humulin R insulin by the following sliding scale . . .
20. CBC with differential q AM
21. SMA 12
22. SMA 6 q AM
23. Cardiology consult stat
```

Table 3 illustrates a list of patient attributes, as shown in Table 1, correlated with a list of orders, as shown in Table 2, in accordance with a preferred embodiment of the present invention. Preferably, the orders are correlated with the associated patient attributes that justify them.

TABLE 3

| Order | Associated Patient Attributes |
|---|---|
| Admit to telemetry | Risk for arrhythmia |
| Diagnosis: chest pain | |
| Vital signs q one hour | Risk for arrhythmia, Rule out |
| | myocardial infarction, Rule out |
| | pulmonary embolism |
| Strict intake and output | Rule out myocardial infarction, Rule |
| | out pulmonary embolism |
| Bed rest with bedside commode | Rule out myocardial infarction, Rule |
| | out pulmonary embolism, Risk for |
| | arrhythmia |
| IV: D5 1/2 normal saline with 20 | Risk for arrhythmia |
| milliequivalents kcl/liter via large | |
| bore catheter at KVO | |
| Pulse oximetry continuous | Risk for tissue hypoxia |
| monitoring | |
| ABG stat | Risk for tissue hypoxia |
| 02, two liters per nasal cannula | Risk for tissue hypoxia |
| Nitroglycerin drip, titrate per | Known coronary vascular disease, |
| protocol | Rule out myocardial infarction, Risk |
| | for tissue hypoxia, Mild congestive |
| | heart failure, stable |
| EKG q 12 hours times three | Rule out myocardial infarction |
| CPK MB stat and q 8 hours | Rule out myocardial infarction |
| times two | |
| Troponin I stat, now and at | Rule out myocardial infarction |
| 12 hours | |
| D-dimer stat | Rule out pulmonary embolism |
| Portable chest x-ray stat | Rule out pulmonary embolism, Rule |
| | out pneumonia |
| Aspirin 325 mg q.d. | Rule out myocardial infarction |
| Lasix 20 mg PO q.d. | Mild congestive heart failure, stable |
| Glucometer reading prior to each | Type II diabetic, suboptimal control |
| meal and at bedtime | |
| Humulin R insulin by the | Type II diabetic, suboptimal control |
| following sliding scale . . . | |
| CBC with differential q AM | Risk for tissue hypoxia |
| SMA 12 | Mild congestive heart failure, stable |
| | Diabetic nephropathy |
| | Risk for arrhythmia |
| SMA 6 q AM | Mild congestive heart failure, stable |
| | Diabetic nephropathy |
| | Risk for arrhythmia |
| Cardiology consult stat | Rule out myocardial infarction |
| | Known coronary vascular disease |

Table 4 illustrates the orders, as shown in Table 3, grouped under corresponding attributes, as shown in Table 3, in accordance with a preferred embodiment of the present invention. Thus, the patient's orders can be represented as a constellation of smaller, attribute-directed order sets (with some orders existing in more than one set).

TABLE 4
Diabetic nephropathy

SMA 12
SMA 6 q AM

Known coronary vascular disease

Nitroglycerin drip, titrate per protocol
Cardiology consult stat

Mild congestive heart failure, stable

Lasix 20 mg PO q.d.
SMA 12
SMA 6 q AM
Nitroglycerin drip, titrate per protocol

Risk for arrhythmia

SMA 6 q AM
SMA 12
Admit to telemetry
IV: D5 1/2 normal saline with 20
milliequivalents kcl/liter via large bore
catheter at KVO
Vital signs q one hour
Bed rest with bedside commode

Risk for tissue hypoxia

Pulse oximetry continuous monitoring
ABG stat
02, two liters per nasal cannula
CBC with differential q AM
Nitroglycerin drip, titrate per protocol

Rule out myocardial infarction

Vital signs q one hour
EKG q 12 hours times three
CPK MB stat and q 8 hours times two
Troponin I stat, now and at 12 hours
Aspirin 325 mg q.d.
Nitroglycerin drip, titrate per protocol
Cardiology consult stat
Strict intake and output
Bed rest with bedside commode
Rule out pneumonia
Portable chest x-ray stat

Rule out pulmonary embolism

Vital signs q one hour
Strict intake and output
Bed rest with bedside commode
D-dimer stat
Portable chest x-ray stat

Type II diabetic suboptimal control

Glucometer reading prior to each meal and at
bedtime
Humulin R insulin by the following sliding
scale . . .

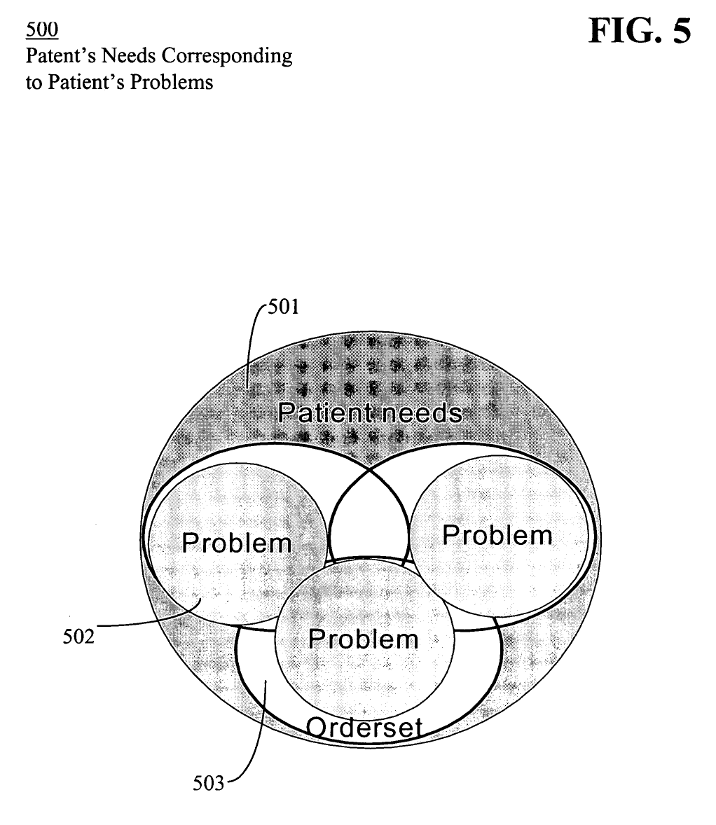

FIG. 5 illustrates a diagram 500 showing a patient's needs 501, represented as a constellation of patient attributes 502 (i.e., patient problems), corresponding to a cluster of order sets 503 addressing the patient attributes 502, in accordance with a preferred embodiment of the present invention. FIG. 5 shows graphically how the patient's needs 501 are represented as a constellation of attributes 502 (labeled here as “Problem”) and that a constellation of order sets, each individually associated with an attribute 502 can be assembled into a group of orders which “fit” the patient's needs 501. For example, with the patient referred to in the Tables 1-4, the orders for “Risk for tissue hypoxia” occurred in the context of the patient's chest pain. However, it is likely that these same orders would fit in numerous other conditions that imply tissue hypoxia, such as pneumonia, acute congestive heart failure, pulmonary embolism, hypotension, asthma, etc. The order set below represents a unit of reusability able to be aggregated with other order sets to fit a patient's problem. FIG. 5 is further described with reference to the following two tables, Tables 5 and 6.

Table 5 illustrates a one particular order set from the patient's problem, as shown in Table 4, that is combined with other sets from other patient's problems, in accordance with a preferred embodiment of the present invention. Because these units of reusability exist naturally (i.e., physicians frequently make similar choices given the same rationale for an accepted standard of case), it is possible to analyze large volumes of patient orders and/or other clinical documents to identify orders that occur together with significant frequency.

TABLE 5
Risk for tissue hypoxia

Pulse oximetry continuous monitoring
ABG stat
02, two liters per nasal cannula
CBC with differential q AM
Nitroglycerin drip, titrate per protocol

Table 6 illustrates a number of possible combinations of the orders, as shown in Table 2, in accordance with a preferred embodiment of the present invention. For example, column 1 shows the number of items. Column 2 shows the number of members in the order set. Column 3 shows the number of combinations. Column 4 shows the number of total combinations.

TABLE 6

| # of | | | |
|---|---|---|---|
| Items | # of members in orderset | # of combinations | total combinations |
| 23 | 1 | 23 | 8388607 |
| | 2 | 253 | |
| | 3 | 1771 | |
| | 4 | 8855 | |
| | 5 | 33649 | |
| | 6 | 100947 | |
| | 7 | 245157 | |
| | 8 | 490314 | |
| | 9 | 817190 | |
| | 10 | 1144066 | |
| | 11 | 1352078 | |
| | 12 | 1352078 | |
| | 13 | 1144066 | |
| | 14 | 817190 | |
| | 15 | 490314 | |
| | 16 | 245157 | |
| | 17 | 100947 | |
| | 18 | 33649 | |
| | 19 | 8855 | |
| | 20 | 1771 | |
| | 21 | 253 | |
| | 22 | 23 | |
| | 23 | 1 | |

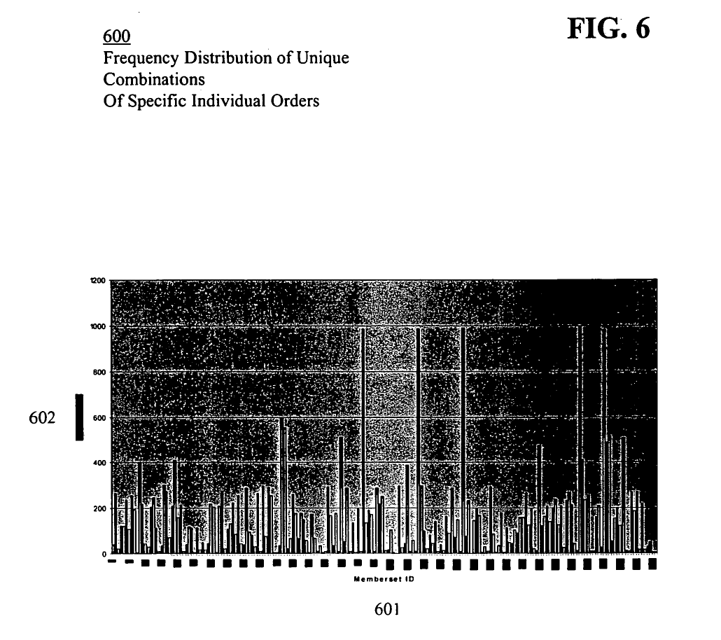

FIG. 6 illustrates a graph 600 showing a frequency distribution of unique combinations of specific individual orders (i.e., a member set), in accordance with a preferred embodiment of the present invention. In FIG. 6, member set ID is represented along a horizontal, “x”, axis 601 of the graph 600 and frequency of use for each member set ID is represented on the vertical, “y”, axis 602 of the graph 600. Following the example in the tables above, with the 23 orders in the single patient order set in Table 2, there are 23 possible order sets with 1 member, and 253 combinations with two members, and so on. Table 6 shows the 8388607 possible permutations of orders, with each set occurring exactly once. If statistical permutations from this single order set for a single patient were analyzed for relative frequency, all frequencies would be the same. However, when admitting order sets from many patients are analyzed, wherein each individual order set contributes all of its possible permutations for each size member set, then certain member sets occur with increasing frequency, as shown in FIG. 6.

For example, the items in Table 5 frequently occur in association with each other, despite the fact that they are part of admission orders for different patients, presenting with different problems (such as myocardial infarction, pneumonia, congestive heart failure, asthma).

Further, orders for other conditions that are frequently associated with “risk for tissue hypoxia” would also be noted to occur with relatively high frequency in association with these orders. For example, there is likely a high correlation between “02, two liters per nasal cannula (i.e., “NC”)” (item 9 Table 2) and “Troponin I.” The high correlation occurs because patients being ruled out for a myocardial infarction most of the time are placed on oxygen. However, “pulse oximetry” and “02, two liters per NC” would be associated far more frequently together than either would be with Troponin I, since most patients being treated with oxygen are not being screened for an MI (Myocardial Infarction).

Each permutation of member set represents a unique combination of specific individual orders. A single order would appear in member sets of different sizes (combined with one, then two, then three other orders and so on). Across aggregate patients, each unique membership would have a certain frequency. FIG. 6 displays a simplified frequency distribution of these member sets. In FIG. 6, one vertical bar represents a collection of orders. A single order belongs to more than one member set, because it appears within multiple permutations and because it may be a valid for a number of discrete rationales.

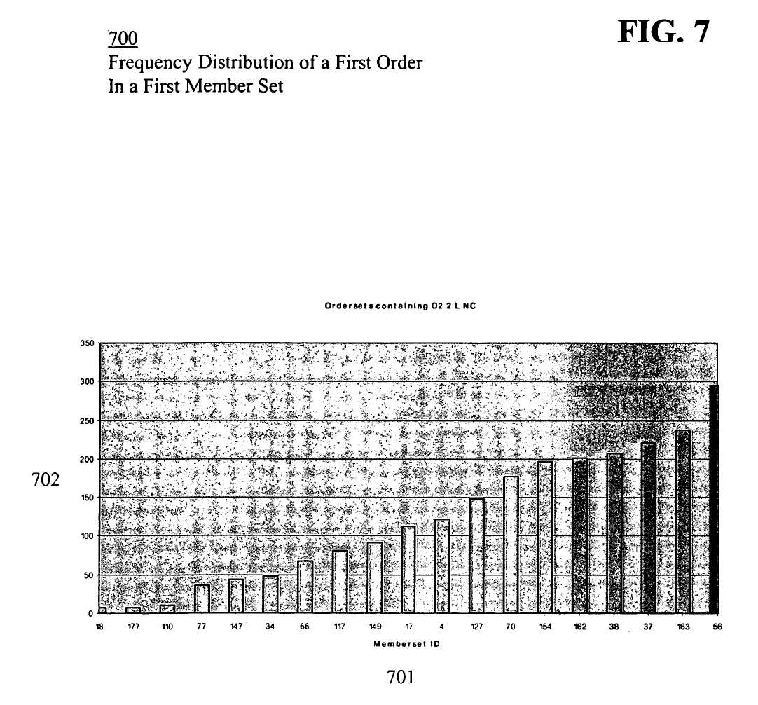

FIG. 7 illustrates a graph 700 showing frequency distribution of a first particular order in a first particular member set, in accordance with a preferred embodiment of the present invention. In FIG. 7, member set ID is represented along a horizontal, “x”, axis 701 of the graph 700 and frequency of use for each member set ID is represented on the vertical, “y”, axis 702 of the graph 700. FIG. 7 illustrates order sets containing oxygen per nasal canula. When the system 100 and the method 200 analyze a particular order (such as oxygen per nasal canula) based upon the frequencies of the member sets to which it belongs and identifies a distribution, which shows the member sets that contain the oxygen order ordered by increasing frequency.

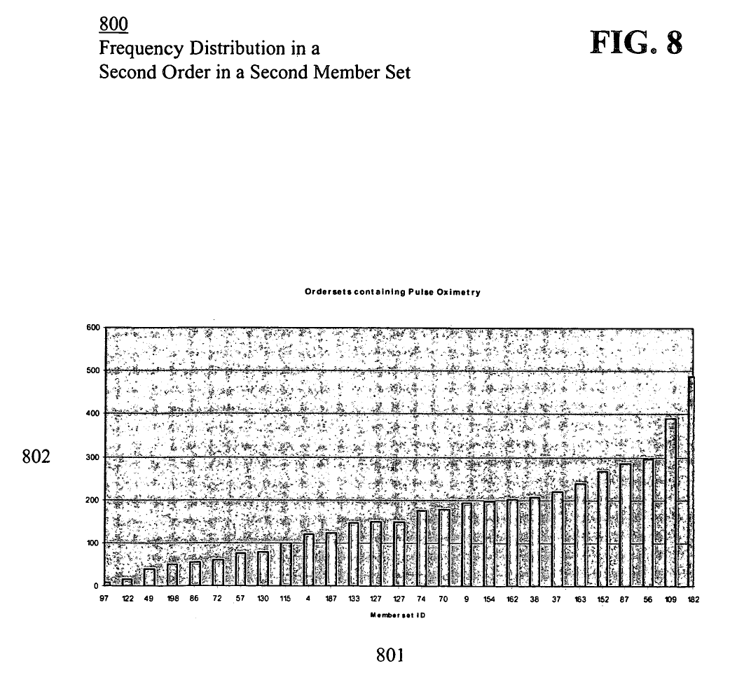

FIG. 8 illustrates a graph 800 showing a frequency distribution of a second particular order in a second particular member set, in accordance with a preferred embodiment of the present invention. In FIG. 8, member set ID is represented along a horizontal, “x”, axis 801 of the graph 800 and frequency of use for each member set ID is represented on the vertical, “y”, axis 802 of the graph 800. It is possible to create a similar analysis for each of the other orders, which are contained within the member sets that contain oxygen, such as for the order set for “Pulse Oximetry,” as shown in FIG. 8.

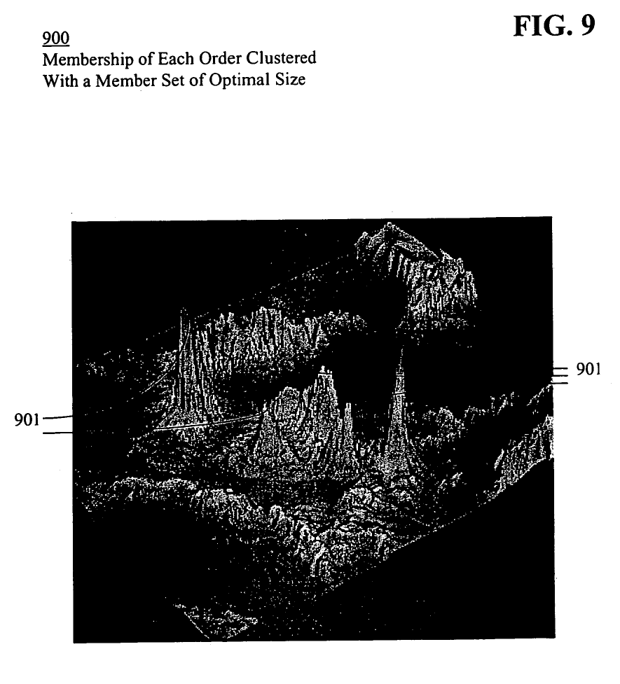

FIG. 9 illustrates a three dimensional plot 900 of the membership of each order clustered with a member set of optimal size for reuse, in accordance with a preferred embodiment of the present invention. Each order provides a dimension for cluster analysis. Further, the quantity of orders contained within each member set provides another dimension. By combining these into a multi-dimensional analysis, an n-dimension topographical representation of the member sets size and membership is created. For example, FIG. 9 shows as a 3-dimensional topographical representation.

Using known mathematical techniques such as fuzzy cluster analysis, the membership of each order can be clustered within a member set of optimal size for reusability (i.e., generating a high frequency of use in the order sets). Preferably, FIG. 9 is color or shade coded to permit peaks 901 of various heights above the floor to represent various levels of correlation. In FIG. 9, if peaks represent commonality (i.e. high correlation) of orders within member sets, and color represents size of membership, with height being frequency, then for each peak, the point at which the slope degrades to an arbitrary minimum threshold, represents an optimal member set size and constituency for that cluster.

After a cluster is identified through this method, medical content experts examine its contents and determine the probable rationale for the cluster, using clinical data from the member patients, when required. The identity of the cluster is then fixed and the analysis is re-run, permitting related member sets, represented by the shoulders of the graphical mountains in FIG. 9, to be re-clustered into individual peaks.

For example, it is likely that oxygen per nasal canula and pulse oximetry would be assigned to the same cluster (designated “Tissue Hypoxia”). Troponin I, a blood test for myocardial infarction diagnosis would occur frequently in association with oxygen, since almost all patients suspected of having a myocardial infarction (MI) would be placed on oxygen. However, since only a minority of patients on oxygen would be suspected of having an MI, these clusters would occur on the “lower slopes” of the oxygen peaks in FIG. 9. Once the oxygen is segregated to an assigned cluster, then the orders associated with diagnosing an MI (e.g., Troponin I, CPK-MB, EKG) would be found to cluster together in a peak that is associated with the oxygen peak. Likewise, orders pertaining to treatment of pneumonia would also form a separate peak, in proximity to the oxygen peak. Hence, the system 100 and method 200 identifies clusters, fixes their size and contents, and analyzes associated data to determine associated clusters.

Once the system 100 and the method 200 generate the clinical model 126, the same system and method are used to provide surveillance of the cluster contents. New items appearing frequently in association with an identified cluster of a member set are automatically detected once their frequency reaches a predetermined threshold. Further, new items are tracked for the rate of change of their frequency, allowing items with high rates of change to be automatically flagged and medical content experts notified even while their utilization rate remains low.

Hence, the system 100 and the method 200 observe changes in ordering patterns of actual clinical practices to aggregate data. The system 100 and the method 200 analyze the data to create a set theory model 126 representing those patterns. The system 100 and the method 200 evaluate the model to target the membership of order sets using specific rationales. The system 100 and the method 200 permit manual review for manual validation. The system 100 and the method 200 evaluate changing memberships within the model 126 and provide self-monitoring, automated, notification of those changes to permit update in the order sets and/or other clinical documentation.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A system for analyzing data comprising healthcare orders initiating treatment or services used in patient healthcare, comprising:
a data processor for identifying a potential change in use of a particular treatment by,
examining data representing a plurality of orders generated over a particular time period and used in treating a plurality of patients, to identify a number of orders initiating application of a particular treatment to individual patients of said plurality of patients to address a particular medical condition and
determining at least one of, (a) whether said number of orders exceeds a predetermined threshold and (b) whether a rate of change in said number of orders relative to a previously determined number of orders is significant; and
a message processor for initiating generation of a message to alert a message recipient of an identified potential change in use of said particular treatment.

2. The system of claim 1, including
an acquisition processor for acquiring data representing said plurality of orders used in treating said plurality of patients and for associating an individual order with at least one of, (a) said particular medical condition and (b) a set of medical conditions including said particular medical condition.

3. The system of claim 1, including
an acquisition processor for acquiring data identifying a plurality of medical conditions exhibited by an individual patient and for applying said data identifying said plurality of medical conditions exhibited by said individual patient in associating said individual order with said at least one of, (a) said particular medical condition and (b) a set of medical conditions including said particular medical condition.

4. The system of claim 3, wherein
said acquisition processor derives data identifying said plurality of medical conditions and potentially associated sub-conditions, wherein a potentially associated sub-condition of a medical condition is identified using a clinical knowledge model that associates medical conditions based upon one of potential etiology, potential complication, clinical associations, and a combination thereof.

5. The system of claim 3, wherein
said data identifying said plurality of medical conditions exhibited by said individual patient is acquired from a stored patient record.

6. The system of claim 1, wherein
said potential change in use of said particular treatment comprises at least one of, (a) a change in frequency of use of said particular treatment by physicians to treat said particular medical condition and (b) a change in type of medical condition treated with said particular treatment.

7. The system of claim 1, wherein
said data processor correlates data representing a particular order of said plurality of orders with at least one of, (a) said particular medical condition, (b) another order of said plurality of orders and (c) a documentation template used for initiating an order.

8. The system of claim 7, wherein
said data processor performs said correlation using at least one of, (i) cluster analysis, (ii) best fit analysis and (iii) a statistical correlation technique.

9. The system of claim 1, wherein
said message processor initiates generation of a message prompting a user with a suggestion of at least one of, (a) an additional order item to be added to an existing order set documentation template and (b) a deletion of an order item from an existing order set documentation template.

10. The system of claim 1, wherein
a second message is received in response to said message alert and
said second message initiates at least one of, (a) an addition of an order item to an existing order set documentation template and (b) a deletion of an order item from an existing order set documentation template.

11. The system of claim 1, wherein
an acquisition processor for acquiring data identifying a plurality of medical conditions exhibited by an individual patient and
applying said data identifying said plurality of medical conditions exhibited by said individual patient in associating said individual order with said at least one of, (a) said particular medical condition and (b) a set of medical conditions including said particular medical condition.

12. The system of claim 1, wherein
said data processor monitors data representing orders to identify said data representing said plurality of orders for examining based on at least one of, (i) a predetermined particular order item in an order set, (ii) a predetermined particular order documentation template, (iii) a source of a predetermined particular order and (iv) a predetermined particular medical condition likely to be associated with an order.

13. A system for suggesting to a user an alteration to an existing documentation order template used for initiating treatment or services used in patient healthcare, comprising:
a data processor for identifying a potential change in use of a particular treatment by,
examining data representing a plurality of orders generated over a particular time period and used in treating a plurality of patients, to identify a number of orders initiating application of a particular treatment to individual patients of said plurality of patients to address a particular medical condition and
determining whether a change in said number of orders relative to a previously determined number of orders is significant, and
prompting a user with a suggestion of at least one of, (a) an additional order item to be added to an existing order set documentation template and (b) a deletion of an order item from an existing order set documentation template.

14. A system for analyzing data comprising healthcare orders initiating treatment or services used in patient healthcare, comprising:
an acquisition processor for acquiring data representing said plurality of orders used in treating said plurality of patients and for associating an individual order with at least one of, (a) said particular medical condition and (b) a set of medical conditions including said particular medical condition;
a data processor for identifying a potential change in use of a particular treatment by,
examining data representing a plurality of orders associated with a particular medical condition and generated over a particular time period and used in treating a plurality of patients, to identify a number of orders initiating application of a particular treatment to individual patients of said plurality of patients and
determining whether a change in said number of orders relative to a previously determined number of orders is significant; and
a message processor for initiating generation of a message to alert a message recipient of an identified potential change in use of said particular treatment.

15. A method for analyzing data comprising healthcare orders initiating treatment or services used in patient healthcare to identify a potential change in use of a particular treatment, comprising the steps of:
examining data representing a plurality of orders generated over a particular time period and used in treating a plurality of patients, to identify a number of orders initiating application of a particular treatment to individual patients of said plurality of patients to address a particular medical condition and
determining at least one of, (a) whether said number of orders exceeds a predetermined threshold and (b) whether a rate of change in said number of orders relative to a previously determined number of orders is statistically significant; and
initiating generation of a message to alert a message recipient of an identified potential change in use of said particular treatment.

16. A method according to claim 15 wherein
said determining step determines at least one of, (a) whether said number of orders exceeds a predetermined threshold and (b) whether a rate of change in said number of orders relative to a previously determined number of orders is statistically significant.
